(19) United States
(12) Patent Application Publication
(10) Pub. No.: US 2016/0148229 A1
(43) Pub. Date: May 26, 2016

(54) WEATHER-BASED INDUSTRY ANALYSIS SYSTEM

(71) Applicant: LOCATOR IP, L.P., State College, PA (US)

(72) Inventors: Michael R. ROOT, Edmond, OK (US); Joel N. Myers, State College, PA (US); Barry Lee Myers, State College, PA (US); James T. Candor, State College, PA (US); Steven Smith, State College, PA (US); Jonathan Porter, Stage College, PA (US); Carla Johnson Callis, Leesburg, VA (US)

(21) Appl. No.: 15/011,103

(22) Filed: Jan. 29, 2016

Related U.S. Application Data
(63) Continuation-in-part of application No. PCT/US14/49198, filed on Jul. 31, 2014.
(60) Provisional application No. 61/860,751, filed on Jul. 31, 2013.

(51) Int. Cl. G06Q 30/02; G01W 1/10

(52) U.S. Cl. CPC G06Q 30/0202; G01W 1/10

(57) ABSTRACT

A weather-based industry analysis system that determines one or more correlations between historical industry performance data and historical meteorological data, determines one or more predicted weather conditions, generates an industry forecast based on the one or more predicted weather conditions and the correlation between the historical industry performance data and the predicted weather conditions, and outputs the industry forecast for transmittal to a remote computer system.

### CROSS REFERENCE TO RELATED APPLICATION

The present application is a continuation-in-part of PCT Patent Application No. PCT/US14/49198, filed Jul. 31, 2014, which claims the benefit of U.S. Provisional Patent Application No. 61/860,751, filed Jul. 31, 2013. The disclosure of both of the aforementioned applications are hereby incorporated by reference in their entireties.

### FIELD OF THE INVENTION

The present invention is directed to a system and method for generating an industry forecast based on a correlation between historical industry performance and historical meteorological data.

### BACKGROUND

In many industries, weather conditions can have a significant impact on the availability of certain commodities and the performance of certain companies. In the energy industry, for example, extreme hot or cold temperatures increase the demand for energy, which causes the prices for electricity and natural gas to rise. Extreme weather conditions and events (e.g., hurricanes) can also increase energy costs by disrupting the supply of electricity and natural gas. Similarly, abnormal temperature and precipitation in specific regions can affect the production of certain agricultural crops.

Producers and buyers of commodities (e.g., raw materials, agricultural products, etc.) may buy and sell futures contracts for those commodities in order to reduce the risk of financial loss due to a change in the price of those commodities. Others may hope to profit from changes in commodities prices by buying and selling futures contracts for commodities without taking delivery of the commodity itself Investors may also buy and sell stocks of companies whose performance is dependent on weather events. In the energy industry, for example, an investor predicting higher oil prices may buy stock in drillers, refiners, tanker companies, and/or diversified oil companies.

A simple correlation between one weather condition and industry performance—like a temperate summer being good for agricultural producers—may be easy for investors to recognize. However, because both industry performance and weather conditions can be measured using dozens of variables, some of the correlations between specific weather conditions and industry performance metrics may only be apparent using statistical modeling of large data sets.

Weather and climate predictions require statistical modeling of large data sets. Weather conditions may be forecast using statistical models that initialize and forecast the meteorological information for future times at given locations and altitudes. Global forecast models, for example, use a set of nonlinear partial differential equations (generally referred to as “the primitive equations”) to approximate global atmospheric flow. Along with the ideal gas law, the primitive equations are used to evolve the density, pressure, and potential temperature scalar fields and the flow velocity vector field of the atmosphere through time. Additional transport equations for pollutants and other aerosols may be included in some high-resolution models. Because the nonlinear partial differential equations are impossible to solve exactly through analytical methods (except in a few idealized cases), numerical methods obtain approximate solutions. Different global forecast models use different solution methods.

Climate models use quantitative methods to simulate the interactions of the important drivers of climate (e.g., the atmosphere, oceans, land surface, and ice) and develop future projections of future climate. In their simplest form, climate models take account of incoming energy from the sun and outgoing electromagnetic energy. Any imbalance results in a change in temperature.

Accordingly, there is a need for a weather-based industry analysis system that determines one or more correlations between historical industry performance data and historical meteorological data, determines one or more predicted weather conditions, and generates an industry forecast based on the one or more predicted weather conditions and the correlation between the historical industry performance data and the predicted weather conditions.

### SUMMARY

In order to overcome these and other disadvantages in the related art, there is provided a weather-based industry analysis system that determines one or more correlations between historical industry performance data and historical meteorological data, determines one or more predicted weather conditions, and generates an industry forecast based on the one or more predicted weather conditions and the correlation between the historical industry performance data and the predicted weather conditions.

### BRIEF DESCRIPTION OF THE DRAWINGS

A preferred embodiment of the present invention will be set forth in detail with reference to the drawings, in which:

FIG. 1 is a block diagram of a weather-based industry analysis system according to an exemplary embodiment of the present invention;

FIG. 2 is a diagram illustrating an architecture of the weather-based industry analysis system illustrated in FIG. 1 according to an exemplary embodiment of the present invention; and

FIG. 3 is a flow chart illustrating a process for generating an industry forecast according to an exemplary embodiment of the present invention.

### DETAILED DESCRIPTION

Preferred embodiments of the present invention will be set forth in detail with reference to the drawings, in which like reference numerals refer to like elements or steps throughout.

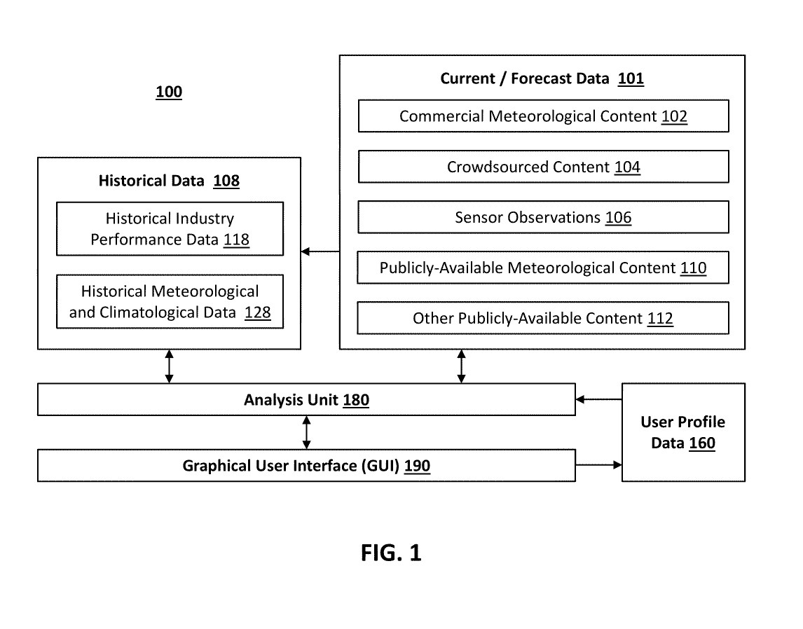

FIG. 1 is a block diagram of a weather-based industry analysis system 100 according to an exemplary embodiment of the present invention. The weather-based industry analysis system 100 stores historical data 108 and current/forecast data 101 and also includes an analysis unit 180 and a graphical user interface 190. The weather-based industry analysis system 100 may also store user profile data 160. The historical data 108 includes historical industry performance data 118 and historical meteorological and climatological data 128. The current/forecast data 101 may include commercial meteorological content 102, crowdsourced content 104, sensor observations 106, publicly-available meteorological content 110, and other publicly-available content 112.

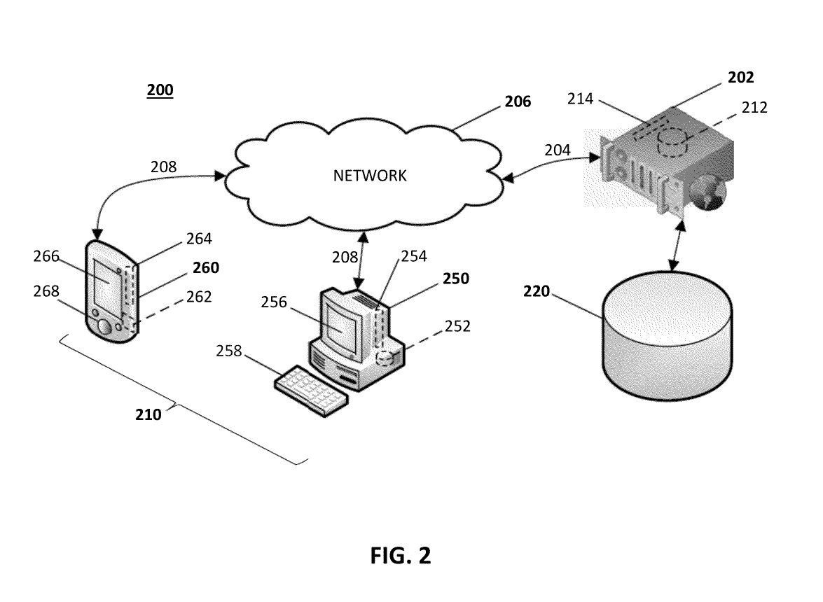

FIG. 2 is a drawing illustrating an overview of the architecture 200 of the weather-based industry analysis system 100 according to an exemplary embodiment of the present invention. The architecture 200 may include one or more servers 202 and one or more storage devices 220 connected to a plurality of remote computer systems 210, such as one or more personal systems 250 and one or more mobile computer systems 260, via one or more networks 206 and communication links 204 and 208.

The one or more servers 202 may include an internal storage device 212 and a processor 214. The one or more servers 202 may be any suitable computing device including, for example, an application server and a web server which hosts websites accessible by the remote computer systems 210. The one or more storage devices 220 may include external storage devices and/or the internal storage device 212 of the one or more servers 202. The one or more storage devices 220 may also include any non-transitory computer-readable storage medium, such as an external hard disk array or solid-state memory. The networks 206 may include any combination of the internet, cellular networks, wide area networks (WAN), local area networks (LAN), etc. Communication via the networks 206 may be realized by communication links 204 and 208, which may be wired and/or wireless connections. A remote computer system 210 may be any suitable electronic device configured to send and/or receive data via the networks 206. A remote computer system 210 may be, for example, a network-connected computing device such as a personal computer, a notebook computer, a smartphone, a personal digital assistant (PDA), a tablet, a notebook computer, a portable weather detector, a global positioning satellite (GPS) receiver, network-connected vehicle, a wearable device, etc. A personal computer system 250 may include an internal storage device 252, a processor 254, output devices 256 and input devices 258. The one or more mobile computer systems 260 may include an internal storage device 262, a processor 264, output devices 266 and input devices 268. An internal storage device 212, 252, and/or 262 may include one or more non-transitory computer-readable storage mediums, such as hard disks or solid-state memory, for storing software instructions that, when executed by a processor 214, 254, or 264, carry out relevant portions of the features described herein. A processor 214, 254, and/or 264 may include a central processing unit (CPU), a graphics processing unit (GPU), etc. A processor 214, 254, and 264 may be realized as a single semiconductor chip or more than one chip. An output device 256 and/or 266 may include a display, speakers, external ports, etc. A display may be any suitable device configured to output visible light, such as a liquid crystal display (LCD), a light emitting polymer displays (LPD), a light emitting diode (LED), an organic light emitting diode (OLED), etc. The input devices 258 and/or 268 may include keyboards, mice, trackballs, still or video cameras, touchpads, etc. A touchpad may be overlaid or integrated with a display to form a touch-sensitive display or touchscreen.

Referring back to FIG. 1, the commercial meteorological content 102 may include current and forecasted weather conditions from private companies such as AccuWeather, Inc., AccuWeather Enterprise Solutions, Inc., Vaisalia's U.S. National Lightning Detection Network, Weather Decision Technologies, Inc., etc. The commercial meteorological content 102 may include analysis (e.g., forecasted weather conditions) generated based on the publicly-available meteorological content 110. In addition to forecasted weather conditions, the commercial meteorological content 102 may include forecasted climate conditions. Forecasted weather conditions generally refer to short term predictions (as short as minutes or as long as months in the future) regarding the predicted state of the atmosphere over short time periods (e.g., daily, hourly, etc.). Climate conditions generally refer to an average of weather conditions for a particular region over a longer time period (e.g., 30 years). The commercial meteorological content 102 may be any organized collection of information, whether stored on a single tangible device or multiple tangible devices. The commercial meteorological content 102 may be stored, for example, in the one or more storage devices 220.

The crowdsourced content 104 may include observations regarding the current weather conditions from individuals (such as members of the Spotter Network) and analysis (e.g., amateur forecasts) made available by members of the public. The crowdsourced content 104 may be any organized collection of information, whether stored on a single tangible device or multiple tangible devices. The crowdsourced content 104 may be stored, for example, in the one or more storage devices 220.

The sensor observations 106 may include observations regarding current weather conditions from weather sensors. The weather sensors and weather sensor data may be maintained and output by government agencies (e.g., the NWS) or private entities. The sensor observations 106 may include observations regarding temperature, humidity, precipitation, cloudiness, brightness, visibility, wind, atmospheric pressure, etc. The sensor observations 106 may be any organized collection of information, whether stored on a single tangible device or multiple tangible devices. The sensor observations 106 may be stored, for example, in the one or more storage devices 220.

The publicly-available meteorological content 110 may include current and forecasted weather and climate conditions received from publicly available sources, such as governmental agencies (e.g., the National Weather Service (NWS), the National Hurricane Center (NHC), Environment Canada, the U.K. Meteorologic Service, the Japan Meteorological Agency, etc.). The publicly-available meteorological content may also include information regarding natural hazards (such as earthquakes) received from, for example, the U.S. Geological Survey (USGS). The publicly-available meteorological content 110 may be any organized collection of information, whether stored on a single tangible device or multiple tangible devices. The publicly-available meteorological content 110 may be stored, for example, in the one or more storage devices 220.

Current weather conditions may include any observation about the current state of the atmosphere, including observations from weather satellites, radiosondes (e.g., in weather balloons), pilot reports along aircraft routes, ship reports along shipping routes, reconnaissance aircraft, etc. Forecasted weather conditions may include any prediction regarding the future state of the atmosphere.

Current and forecasted weather conditions may include, for example, the 24-hour maximum temperature, the 24-hour minimum temperature, the air quality, the amount of ice, the amount of rain, the amount of snow falling, the amount of snow on the ground, the Arctic Oscillation (AO), the average relative humidity, the barometric pressure trend, the blowing snow potential, the ceiling, the ceiling height, the chance of a thunderstorm, the chance of enough snow to coat the ground, the chance of enough snow to wet a field, the chance of hail, the chance of ice, the chance of precipitation, the chance of rain, the chance of snow, the cloud cover, the cloud cover percentage, the cooling degrees, the day sky condition, the day wind direction, the day wind gusts, the day wind speed, the dew point, the El Nino Southern Oscillation (ENSO), the evapotranspiration, the expected thunderstorm intensity level, the flooding potential, the heat index, the heating degrees, the high temperature, the high tide warning, the high wet bulb temperature, the highest relative humidity, the hours of ice, the hours of precipitation, the hours of rain, the hours of snow, the humidity, the lake levels, the liquid equivalent precipitation amount, the low temperature, the low wet bulb temperature, the maximum ultraviolet (UV) index, the Multivariate ENSO Index (MEI), the Madden-Julian Oscillation (MJO), the moon phase, the moonrise, the moonset, the night sky condition, the night wind direction, the night wind gusts, the night wind speed, the normal low temperature, the normal temperature, the one-word weather, the precipitation amount, the precipitation accumulation, the precipitation type, the probability of snow, the probability of enough ice to coat the ground, the probability of enough snow to coat the ground, the probability of enough rain to wet a field, the rain amount, the RealFeel®, the RealFeel® high, the RealFeel® low (REALFEEL is a registered service mark of AccuWeather, Inc.), the record low temperature, the record high temperature, the relative humidity range, the sea level barometric pressure, the sea surface temperature, the sky condition, the snow accumulation in the next 24 hours, the solar radiation, the station barometric pressure, the sunrise, the sunset, the temperature, the type of snow, the UV index, the visibility, the wet bulb temperature, the wind chill, the wind direction, the wind gusts, the wind speed, etc. The weather conditions may include weather-related warnings such as river flood warnings, thunderstorm watch boxes, tornado watch boxes, mesoscale discussions, polygon warnings, zone/country warnings, outlooks, advisories, watches, special weather statements, lightning warnings, thunderstorm warnings, heavy rain warnings, high wind warnings, high or low temperature warnings, local storm reports, earthquakes, and/or hurricane impact forecasts. Each weather condition may be expressed based on a time frame, such as the daily value, the hourly forecast value, the daily forecast value, the daily value one year ago, the accumulation or variations over a previous time period (e.g., 24 hours, 3 hours, 6 hours, 9 hours, the previous day, the past seven days, the current month to date, the current year to date, the past 12 months), the climatological normal (e.g., the average value over the past 10 years, 20 years, 25 years, 30 years, etc.), the forecasted accumulation over a future time period (e.g., 24 hours), etc.

The other publicly-available content 112 may include commentary regarding future weather and climate conditions. The other publicly-available content 112 may also include, for example, academic or scientific papers, news articles, blog posts, etc. The other publicly-available content 112 may include, for example, meteorological and/or climatological models or predicted weather and/or climate conditions based on those models. The other publicly-available content 112 may also be any organized collection of information, whether stored on a single tangible device or multiple tangible devices. The other publicly-available content 112 may be stored, for example, in the one or more storage devices 220.

The historical industry performance data 118 includes information regarding the performance of commodities and companies with certain industries (e.g., energy, agriculture, insurance, retail, etc.) over time, such as stock prices, commodities prices, sales figures, revenue figures, etc. For example, information regarding the energy industry may include information regarding coal production, oil production, natural gas production, etc. In another example, information regarding the agriculture industry may include information regarding the production of each crop. The historical industry performance data 118 may be subdivided based on the geographic location of each activity. For example, information regarding the production of strawberries may include information regarding the production of strawberries in California, Florida, etc. The historical industry performance data 118 may be any organized collection of information, whether stored on a single tangible device or multiple tangible devices. The historical industry performance data 118 may be stored, for example, in the one or more storage devices 220.

The historical meteorological and climatological data 128 may include information indicative of the past weather and climate conditions as described above. The historical meteorological and climatological data 128 may be received from government agencies (e.g., the NWS) and/or private entities (e.g., AccuWeather, Inc.). Additionally, information regarding the current weather conditions included in the current/forecast data 101 may be stored as historical meteorological and climatological data 128 after the time period for the current weather conditions has passed. The historical meteorological and climatological data 128 may be any organized collection of information, whether stored on a single tangible device or multiple tangible devices. The historical meteorological and climatological data 128 may be stored, for example, in the one or more storage devices 220.

The user profile data 160 may include a user profile associated with each user. Each user may subscribe to receive industry forecasts for a particular industry. Additionally, a user may subscribe to receive alerts regarding the particular industry as describe below. The subscription information for each user may be received from each user (e.g., via the graphical user interface 190) and stored in the user profile associated with that user. The user profile data 160 may be any organized collection of information, whether stored on a single tangible device or multiple tangible devices. The user profile data 160 may be stored, for example, in the one or more storage devices 220.

As described in more detail below, the analysis unit 180 is configured to determine correlations between the historical industry performance data 118 and the historical meteorological and climatological data 128 and to predict future performance of an industry, company, commodity, product, or service based on those correlations and forecasted weather conditions included in the current/forecast data 101. The analysis unit 180 may be realized by software instructions stored on one or more of the internal storage devices 212, 252, and/or 262 and executed by one or more of the processors 214, 254, or 264.

The graphical user interface 190 may be any interface that allows a user to input information for transmittal to the weather-based industry analysis system 100 and/or outputs information received from the weather-based industry analysis system 100 to a user. The graphical user interface 190 may be realized by software instructions stored on one or more of the internal storage devices 212, 252, and/or 262 executed by one or more of the processors 214, 254, or 264.

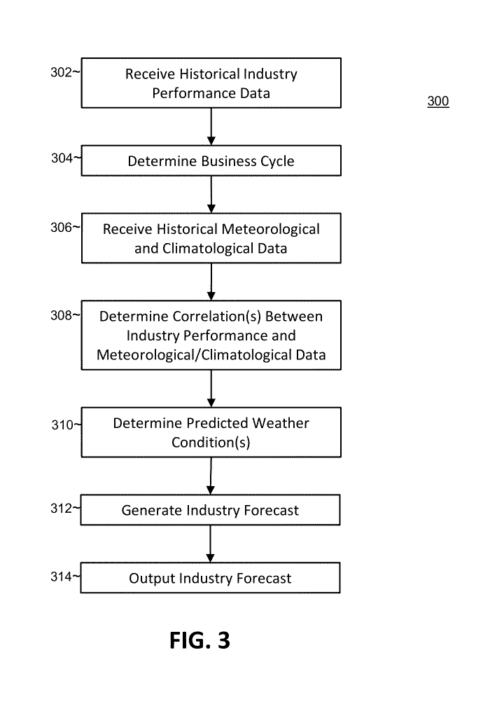

FIG. 3 is a flowchart illustrating a process 300 for generating an industry forecast according to an exemplary embodiment of the present invention. The process 300 may be performed, for example, by the analysis unit 180.

The historical industry performance data 118 is received in step 302. The historical industry performance data 118 may include information indicative of the performance over time of an industry, company, commodity, product, or service.

A business cycle for a particular industry, company, commodity, product, or service is determined in step 304 based on the historical industry performance data 118. Looking at the automotive industry, for example, the analysis unit 180 may determine that automobile production and/or sales follow a certain pattern over the course of a model year. In another example, the analysis unit 180 may determine that an agricultural product is produced in a particular region during a particular time of year and that same agricultural product is produced in another region during another time of year.

The historical meteorological and climatological data 128 is received in step 306.

One or more correlations between the historical industry performance data 118 and the historical meteorological and climatological data 128 are determined in step 308. For example, the analysis unit 180 may determine that a plurality of weather conditions occurring simultaneously is correlated with a certain industry performance. The correlations may be determined based on regression analysis such as a multiple linear regression model, a nonlinear regression model, a polynomial regression model, etc.

One or more predicted weather conditions are determined in step 310. The predicted weather conditions may be included in or based on the commercial meteorological content 102, the crowdsourced content 104, the sensor observations 106, the publicly-available meteorological content 110 and/or the other publicly-available content 112.

An industry forecast is generated in step 312. The industry forecast may include a prediction regarding the performance of an industry, company, commodity, product, or service. The prediction regarding the performance of the industry, company, commodity, product, or service may be for the time period of the predicted weather conditions determined in step 310 or the time period immediately thereafter. The performance of the industry, company, commodity, product, or service may be expressed in terms of sales, revenue, and/or commodity price (either in absolute terms or relative to a current amount). For example, the analysis unit 180 may determine the correlation between the supply of oranges and temperature and precipitation during the growing season in step 308. The analysis unit 180 may also determine in step 310 that the temperature and humidity over the course of the orange growing season are predicted to be in a range that is positively correlated with large crops of oranges. Accordingly, the analysis unit 180 may determine in step 312 that a large crop of oranges will be produced.

A prediction regarding the performance of a company, a company's product, or a company's service may be generated in part based on the size of the company relevant to the company's industry. For example, the analysis unit 180 may determine that the performance of a company with a smaller market share is highly correlated with certain weather conditions whereas the performance of a company with a larger market share in that same industry is not highly correlated with certain weather conditions. Alternatively, the performance of a company with a larger market share may be highly correlated with certain weather conditions whereas the performance of a company with a smaller market share may not be highly correlated with those weather conditions.

The industry forecast is output for transmittal to a remote computer system 210 in step 314. The industry forecast may include a recommendation for the user based on the predicted performance of the industry, company, commodity, product, or service. Returning to the oranges example above, the analysis unit 180 may determine that the large crop of oranges will cause the price of oranges to drop and output a recommendation that the user purchase a put option orange juice contract. Additionally or alternatively, the analysis unit 180 may output a recommendation that the user buy stocks of companies that historically gain value in response to a large orange crop.

The industry forecast may be output for transmittal to a remote computer system 210 in response to a user request received via the graphical user interface 390. Additionally or alternatively, the analysis unit 180 may output the industry forecast to the remote computer system 210 as an alert to a user. The alert may be output to the user based on a comparison between the industry forecast and an alert threshold (determined by the weather-based industry analysis system 100 and/or stored in the user profile data 160 associated with the user). For example, the alert may be output based on a determination that the predicted performance of an industry, company, commodity, product, or service is greater than or equal to an alert threshold.

While a preferred embodiment has been set forth above, those skilled in the art who have reviewed the present disclosure will readily appreciate that other embodiments can be realized within the scope of the present invention. For example, disclosures of specific weather phenomena are illustrative rather than limiting, as are disclosures of specific effects of those phenomena on companies or individuals. Disclosures of specific technologies are also illustrative rather than limiting. Therefore, the present invention should be construed as limited only by the appended claims.

What is claimed is:

1. A method for generating an industry forecast, the method comprising:
determining at least one correlation between historical industry performance data and historical meteorological data;
determining one or more predicted weather conditions;
generating an industry forecast based on the one or more predicted weather conditions and the correlation between the historical industry performance data and the predicted weather conditions; and
outputting the industry forecast for transmittal to a remote computer system.

2. The method of claim 1, wherein the historical meteorological data includes climatological data.

3. The method of claim 1, wherein the predicted weather conditions are based on publicly-available meteorological content, commercial meteorological content, crowdsourced meteorological content, and/or sensor observations.

4. The method of claim 1, wherein the historical industry performance data includes the performance over time of an industry, a company, a commodity, a product, or a service.

5. The method of claim 1, wherein determining at least one correlation between historical industry performance data and historical meteorological data comprises determining a correlation between a plurality of weather conditions occurring simultaneously during one or more time periods and the performance the performance over the one or more time periods of an industry, a company, a commodity, a product, or a service.

6. The method of claim 1, wherein determining at least one correlation between historical industry performance data and historical meteorological data comprises:
determining a business cycle for an industry, a company, a commodity, a product, or a service; and
determining at least one correlation between one or more weather conditions included in the historical meteorological data and the performance of the industry, the company, the commodity, the product, or the service.

7. The method of claim 1, wherein the industry forecast includes a prediction regarding the performance of an industry, a company, a commodity, a product, or a service.

8. The method of claim 1, wherein the industry forecast is output as an alert to a user via the remote computer system.

9. The method of claim 8, wherein the industry forecast is output as an alert based on a comparison of the industry forecast and an alert threshold stored in user profile data associated with the user.

10. The method of claim 1, wherein the industry forecast includes a recommendation for the user.

11. A system, comprising:
non-transitory computer readable storage media that stores historical industry performance data and historical meteorological data; and
an analysis unit that:
determines at least one correlation between the historical industry performance data and the historical meteorological data;
determines one or more predicted weather conditions;
generates an industry forecast based on the one or more predicted weather conditions and the correlation between the historical industry performance data and the predicted weather conditions; and
outputs the industry forecast for transmittal to a remote computer system.

12. The system of claim 11, wherein the historical meteorological data includes climatological data.

13. The system of claim 11, wherein the predicted weather conditions are based on publicly-available meteorological content, commercial meteorological content, crowdsourced meteorological content, and/or sensor observations stored in the non-transitory computer readable storage media.

14. The system of claim 11, wherein the historical industry performance data includes the performance over time of an industry, a company, a commodity, a product, or a service.

15. The system of claim 11, wherein the analysis unit determines the at least one correlation between historical industry performance data and historical meteorological data by:
determining a correlation between a plurality of weather conditions occurring simultaneously during one or more time periods and the performance the performance of an industry, a company, a commodity, a product, or a service over the one or more time periods.

16. The system of claim 11, wherein the analysis unit determines the at least one correlation between historical industry performance data and historical meteorological data by:
determining a business cycle for an industry, a company, a commodity, a product, or a service; and
determining at least one correlation between one or more weather conditions included in the historical meteorological data and the performance of the industry, the company, the commodity, the product, or the service.

18. The system of claim 11, wherein the industry forecast includes a prediction regarding the performance of an industry, a company, a commodity, a product, or a service.

18. The system of claim 11, wherein the industry forecast is output as an alert to a user via the remote computer system.

19. The system of claim 18, wherein the industry forecast is output as an alert based on a comparison of the industry forecast and an alert threshold stored in user profile data associated with the user.

20. The system of claim 11, wherein the industry forecast includes a recommendation for the user.
